(19) United States
(12) Patent Application Publication
(10) Pub. No.: US 2017/0136502 A1
(43) Pub. Date: May 18, 2017

(54) NONWOVEN COMPOSITE INCLUDING NATURAL FIBER WEB LAYER AND METHOD OF FORMING THE SAME

(71) Applicant: First Quality Nonwovens, Inc., Great Neck, NY (US)

(72) Inventors: Peter ZAJACZKOWSKI, Greenville, SC (US); John C. PARSONS, Dallas, PA (US); Karthik RAMARATNAM, Anderson, SC (US)

(21) Appl. No.: 15/351,186

(22) Filed: Nov. 14, 2016

Related U.S. Application Data
(60) Provisional application No. 62/254,528, filed on Nov. 12, 2015.

(51) Int. Cl. B08B 1/00; D04H 3/007; D04H 1/492; D04H 3/11; D04H 18/04

(52) U.S. Cl. CPC B08B 1/006; D04H 3/11; D04H 18/04; D04H 1/492; D04H 3/007; D10B 2321/022

(57) ABSTRACT

A composite structure including at least one paper web layer bonded to at least one nonwoven web layer by a hydroentanglement process. The paper web layer is made of natural fibers processed to have a specified kappa number depending on desired smoothness and hydrophilicity of the composite structure. In an exemplary embodiment, the paper web layer is made of a structured paper web, and the structure of the paper web is imparted to the nonwoven web layer by the hydroentanglement process. In an exemplary embodiment, the composite structure is a wipe product, comprised of a two or three layer structure, with at least one natural fiber layer. Higher machine speeds to produce a two-layer composite web comprised of one natural fiber web is achieved using a protective layer during the hydro-entangling process.

### RELATED APPLICATIONS

This application claims priority to U.S. Provisional Patent Application No. 62/254,528, filed Nov. 12, 2015, entitled NONWOVEN COMPOSITE INCLUDING NATURAL FIBER WEB LAYER AND METHOD OF FORMING THE SAME, the contents of which are incorporated herein by reference in their entirety.

### FIELD OF THE INVENTION

The present invention generally relates to composite structures and in particular to nonwoven composite structures intended for use in a wipe product.

### BACKGROUND

Across the globe there is great demand for disposable wipe products such as sanitary wipes and facial wipes. In the North American market, the demand is increasing for higher quality products offered at a reasonable price point. The quality attributes most important for consumers of such wipes are softness, absorbency and strength.

Conventional wipes are made of nonwoven material to impart the wipes with specific strength characteristics. However, nonwoven material may be too coarse or may not provide the desired absorbency for the final wipe product. Thus, it is also known to introduce pulp fibers into a nonwoven fabric to increase the overall softness and/or absorbency. Conventional methods of adding pulp to nonwoven material include wet-laying or air-laying pulp fibers directly onto spunbmelt material at speeds less than 150 mpm. Attempts to increase machine speeds result in reduced composite web integrity, excessive fiber (pulp) losses in the waste water stream and/or uneven composite material.

### SUMMARY OF THE INVENTION

An object of the present invention is to provide a composite product made of a combination of natural fibers and nonwoven materials in which the product has improved structural integrity and bulk properties compared to conventional products.

Another object of the present invention is to provide a process for making a composite product made of a combination of natural fibers and nonwoven materials in which the process involves the use of average line speeds that are greater than 150 mpm. The natural fiber web used in exemplary embodiments of the present invention preferably has very high wet strength, which allows the web to withstand high machine speeds during both unwinding and hydroentangling processes.

Another object of the present invention is to produce a two-layered composite web comprised of one paper layer and one nonwoven web layer, using a protective layer on top of the paper web during the hydro-entangling process. The protective layer assists with the production of a two-layered paper-nonwoven structure at high machine speeds significantly greater than 150 mpm with less injectors (e.g., 4 to 6 injectors during the hydroentangling process) as compared to conventional processes. By way of contrast, conventional processes for making a two-layered paper non-woven structure involve the use of 8 to 10 injectors at low speeds close to 150 mpm.

Another object of the present invention is to provide a wipe product made of a combination of a natural fiber web and spunbond/spunmelt webs.

A composite structure according to an exemplary embodiment of the present invention comprises at least one paper web layer and at least one nonwoven web layer.

In at least one embodiment, the composite structure includes two nonwoven web layers, and the paper web layer is disposed between the two nonwoven web layers.

In at least one embodiment, the at least one nonwoven web layer is a carded web.

In at least one embodiment, the at least one nonwoven web layer is a spunbmelt web.

In at least one embodiment, the at least one nonwoven web layer is a spunmelt web, a meltblown web or a combination thereof

In at least one embodiment, the composite structure is bonded by a hydro entangling process.

In at least one embodiment, the paper web layer is made of hemp fibers.

In at least one embodiment, the paper web layer is a multi-layered web, more preferably a two or more layered web, comprised of both softwood and hardwood pulp fibers.

In at least one embodiment, the paper web layer includes a permanent wet strength additive.

In at least one embodiment, the paper web layer includes a temporary wet strength additive.

In at least one embodiment, fiber used to form the paper web layer is processed to a kappa number less than 100.

In at least one embodiment, at least one nonwoven web layer is a spunbmelt nonwoven web layer.

In at least one embodiment, the paper web layer is made of a structured paper web.

In at least one embodiment, the composite structure is a wipe product.

According to an exemplary embodiment of the present invention, a method for making a composite structure includes: providing at least one paper web layer and at least one nonwoven web layer; and hydroentangling the at least one paper web layer with the at least one nonwoven web layer.

In at least one embodiment, the paper web layer is made of a structured paper web, and the hydroentangling step imparts the structure of the structured paper web to the at least one nonwoven web layer.

In at least one embodiment, the structured paper web layer has the microstructure and the hydroentangling step imparts a macrostructure to the composite material.

In at least one embodiment, the structured paper web layer has both the micro and macrostructures which is then preserved and kept intact in the composite material during hydroentangling step.

### DESCRIPTION OF THE DRAWINGS

FIG. 1 is a cross-sectional view of a nonwoven composite web according to an exemplary embodiment of the present invention;

FIG. 2 is a block diagram illustrating a hydroentangling process with spunbmelt nonwoven web and paper web according to an exemplary embodiment of the present invention;

FIG. 3 is a block diagram illustrating a hydroentangling process with spunmelt nonwoven web and carded hemp web according to an exemplary embodiment of the present invention;

FIG. 4 is a block diagram illustrating a hydroentangling process according to an exemplary embodiment of the present invention;

FIG. 5A is a block diagram illustrating a two-drum hydroentangling configuration according to an exemplary embodiment of the present invention;

FIG. 5B is a block diagram illustrating a three-drum hydroentangling configuration according to an exemplary embodiment of the present invention;

FIG. 5C is a block diagram illustrating a multi-injector belt hydroentangling configuration; and

FIG. 5D is a block diagram illustrating a two-drum hydroentangling configuration using a protective layer according to an exemplary embodiment of the present invention.

### DETAILED DESCRIPTION

The present invention is directed to the use of natural fibers, such as hemp and/or wood fibers, in combination with spunmelt nonwoven to create spunmelt composite materials with natural anti-microbial properties, with specific application as a replacement to typical melt blown and/or absorbent wipes. Fiber processing of the natural fiber (in particular hemp fiber) is a critical factor in producing a uniform carded web and therefore a uniform composite fabric. This fiber processing is measured in terms of kappa number, which relates to the degree of fiber delignification, as measured in accordance with the T236 TAPPI standard. Varying the kappa number results in either an increase or decrease of the hydrophobicity and hydrophilicity of the composite web. For example, a processed hemp fiber with 50 kappa number will be hydrophilic, fine and smooth compared to an unprocessed hemp fiber with 100 kappa number, which will be less hydrophilic, coarse and abrasive.

Wipes made in accordance with the present invention exhibit natural anti-microbial properties without any significant addition of biocides. Further, tweaking the kappa number enables for a range of products from highly absorbent to less absorbent and/or a range of soft to abrasive products.

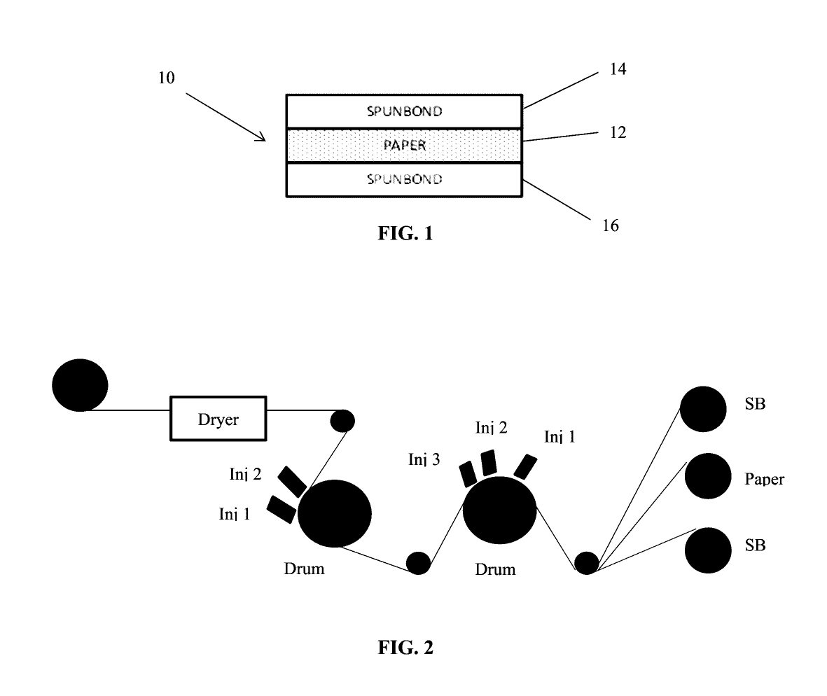

FIG. 1 is a cross sectional view of a composite web, generally designated by reference number 10, according to an exemplary embodiment of the present invention. The web 10 includes an internal layer 12 sandwiched between two outer layers 14 and 16. The internal layer 12 is a paper web material made of natural fiber, preferably hemp or wood fibers. The two outer layers 14, 16 are made of nonwoven web material. Two or more layers of the composite web 10 are bonded together using hydro-entangling, hydro-engorging, thermal calendaring, adhesive bonding or lamination technologies.

The internal layer 12 may be either a structured or non-structured natural fiber web. The natural fiber web may be made using carding, airlaid and or wet-laid technologies, and have a basis weight of 10 gsm to 500 gsm. The natural fibers used include any plant fibers, animal fibers and/or wood fibers, and specific examples include abaca, coir, cotton, flax, hemp, jute, ramie, sisal, alpaca wool, angora wool, camel hair, cashmere, mohair, silk, wool, hardwood, softwood, elephant grass fibers, etc. The natural fiber web is chemically or enzymatically processed to a target kappa number less than 100. Processed natural fiber with a lower kappa number is used predominantly in absorbent products such as ADL's, wipes etc., while processed natural fiber with a high kappa number is predominantly in diaper backsheet, diaper cuff, medical markets etc.

The paper web used for the composite structure formation can be a single layer or multilayered structure. The paper web preferably has high temporary and/or permanent wet strength to maintain structural integrity during a subsequent hydro entangling process. Binder solutions may be sprayed onto the paper web before the hydro entangling process to further protect the basesheet structure. Structure can be imparted to the paper web during a separate pre-entangling process by using a structured fabric or on the HE dewatering belt. The structure of the paper web may be varied depending on the through air dried (TAD) fabric used during the paper making process. Structure can also be imparted to the pulp/paper web in a wet laying process by using a structured fabric and then combining the paper web with a spunbond/spunmelt web.

The nonwoven web material layers 14, 16 may be made of spunbond/spunmelt/spunlace fabrics. Nonwoven base materials used may be spunbond, meltblown and the combinations thereof, using any of thermoplastic polymers available, more specifically polyethylene, polypropylene, polyethylene terephthalate (PET) and/or nylon. Nonwoven base materials may be carded and/or spunlace materials including any of the commonly available thermoplastic staple fibers.

The nonwoven composite fabric has a distinct pattern either from the structured natural fiber web, patterning screens used in the hydroentangling process, E-roll designs, or any other suitable patterning technique. Nonwoven composite fabrics produced have a lofty/bulky appearance due to the use of structured natural fiber webs, and have the ability to conform to additional designs due to the discrete fiber length of the natural fibers as opposed to continuous synthetic fibers. In an exemplary embodiment, the nonwoven composite fabric has two-sidedness due to the preferential presence of spunbond and natural fibers on either sides. The nonwoven composite fabric may have anti-microbial properties due to the micro-structure of certain natural fibers.

In at least one embodiment, the nonwoven composite fabric has an MD/CD tensile ratio range of approximately 2.0 to 3.0. The nonwoven composite fabric also has increased absorbency capacity in the range of 400% to 1000%.

Stable and strong composite webs can be produced using combinations of spunmelt and high wet strength paper basesheet. The amount of wet strength of the paper web is one of the critical factors that determines the integrity of the spun bond composite web and the transferability of the pattern from the paper basesheet onto the composite non-woven material. In other words, the amount of wet strength determines the overall strength of the composite material and its ability to retain the TAD structure/pattern from the original paper web.

The amount of hydroentangling (HE) energy used to make the composite web is another critical factor to retain the patterns transferred from the paper web to the overall composite web. Higher HE energies disrupt the pattern and the composite web is smooth and flat, while lower HE energies produce a patterned and bulky composite material.

Micro and/or macro scale patterns may be further incorporated into the composite web by using a structured paper (micro) and/or a 2 or 3-dimensional shell (macro) during the HE process to combine the spunbond/spunmelt web with the paper web. By using low intensity HE energies the patterns of the natural fiber web are preserved and imparted to the composite web.

The structure of the composite web may either be pre-formed during the paper making process or formed on-line using a structured fabric/conveyor web.

In an exemplary embodiment, additional treatments are applied to the nonwoven composite fabric using kiss roll application. For example, softeners are used to further soften the composite materials and the intake of certain water based softening chemistries are significantly higher due to the presence of hydrophilic natural fibers.

The following examples are illustrative of various features and advantages of the present invention:

### EXAMPLE 1

### Method to Produce a Patterned Composite Web by Hydroentangling Paper and Spunbmelt Webs at Low Energy

A patterned/structured paper web was made using a TAD paper machine. The paper web had permanent wet strength Kymene™ 821 (PAE resin) available from Hercules Incorporated, Wilmington, Del., USA, at add-on levels of at least 6 kg/ton. The patterned structure of the paper web was preserved in the composite non-woven fabric by using a low HE energy intensity during the hydroentangling process. HE energy conditions were 20, 40, 40 bars from the three injection manifolds of drum 1 and 40, 40 bars from the two injection manifolds of drum 2, as shown in FIG. 2.

### EXAMPLE 2

### Method to Produce a Flat Composite Web by Hydroentangling Paper and Spunmelt Webs at High HE Energy

Two identical spunbond polypropylene webs with basis weight of 12 gsm each and a 20 gsm paper web used to make paper towel were hydroentangled together to make a composite non-woven fabric. FIG. 1 shows the web arrangement with the paper web sandwiched between the two spunbond webs.

The patterned/structured paper web was made using a TAD paper machine. The paper web had permanent wet strength Kymene 821 (PAE resin) at add-on levels of at least 6 kg/ton. High HE energy levels was used to entangle the two SB and paper web at 20, 100, 100 bars from the three injection manifolds of drum 1 and 150, 150 bars from the two injection manifolds of drum 2, as shown in FIG. 2. Due to the use of high HE energy levels, the patterned paper web structure was disrupted and lost during the process resulting in flat but strong composite non-woven material.

### EXAMPLE 3

### Method to produce a SB-Hemp-SB Composite Web

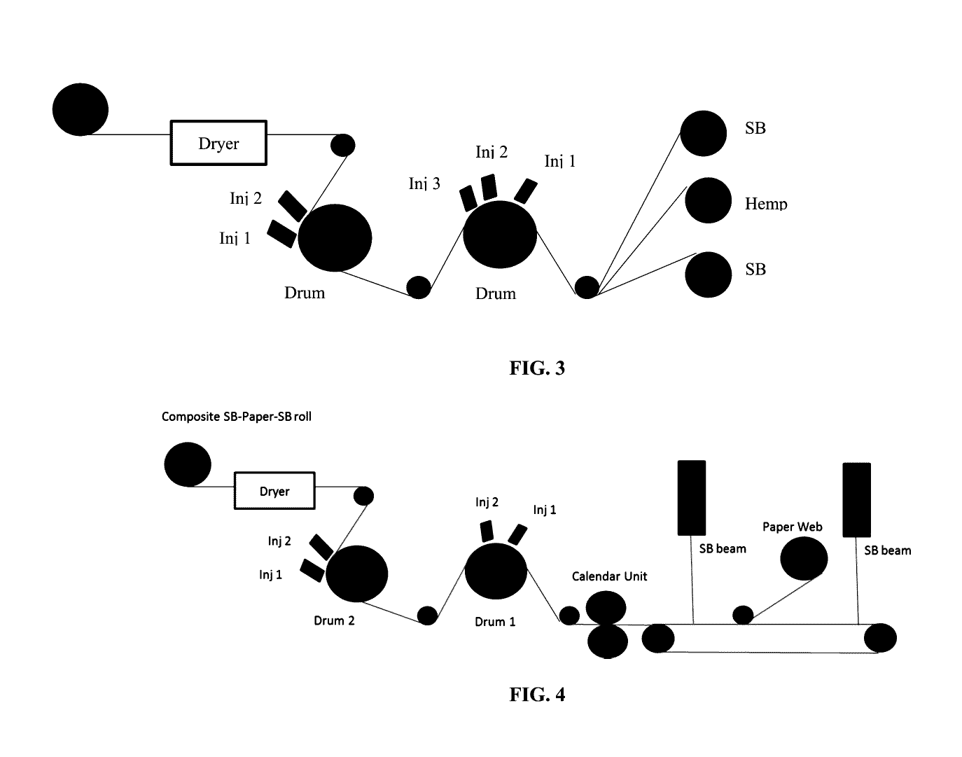

25 gsm hemp carded web was produced using raw unprocessed hemp fibers with fiber lengths ranging from 30 to 60 mm with less than 5% herd content. Then the hemp web was hydroentangled with two identical spunbond webs each at 12 gsm basis weight, as shown in FIG. 3. HE energy levels used to entangle the two SB and hemp web were at 20, 80, 80 bars for the three injection manifolds of drum 1 and 100, 100 bars from the 3 injection manifolds of drum 2, as shown in FIG. 3.

### EXAMPLE 4

### Method to Produce a 3 Layered Patterned Composite Web Using a Spunbond Machine

A three-layer composite web was made on a spunbond/SMS machine (available from Reifenhäuser Reicofil of Troisdorf, Germany) that has an additional hydro-entangling unit and an unwinding unit to unwind paper roll. A 40 gsm three layered paper web produced using a TAD paper machine was unwound between two spunbond beams and subsequently hydro-entangled to make the composite product. The three layered paper web produced using a TAD paper machine was a patterned/structured web. The paper web had permanent wet strength Kymene 821 (PAE resin) at add-on levels of at least 6 kg/Ton. Exxon 3155 polypropylene resin was used to make each of the spunbond layers and the basis weight of each layer was 12.5 gsm. As shown in FIG. 4, the web was tack bonded using a thermal calendaring unit before being fed into the HE unit. Top and bottom calendar roll temperatures were both at 129° C. and the nip pressure was at 25 dN/cm. The HE unit shown in FIG. 4 was used to hydro-entangle the 3 layer web together. HE energy conditions were 180, 240 and 240 bars from one of the injection manifolds of drum 1 and two injection manifolds of drum 2 targeting an HE energy flux of 1 Kwh/kg. A standard MPC-100 shell was used on drum 1 and a 910p shell was used on drum 2 to pattern the composite web. Both shells were supplied by Andritz of Montbonnot, France. Average spinbelt speed was 167 mpm and the drier temperature was 130° C. The product produced using this example had a clear 3-dimensionality with pronounced dots (910p shell pattern) and a water absorbency capacity of ˜400%.

### EXAMPLE 5

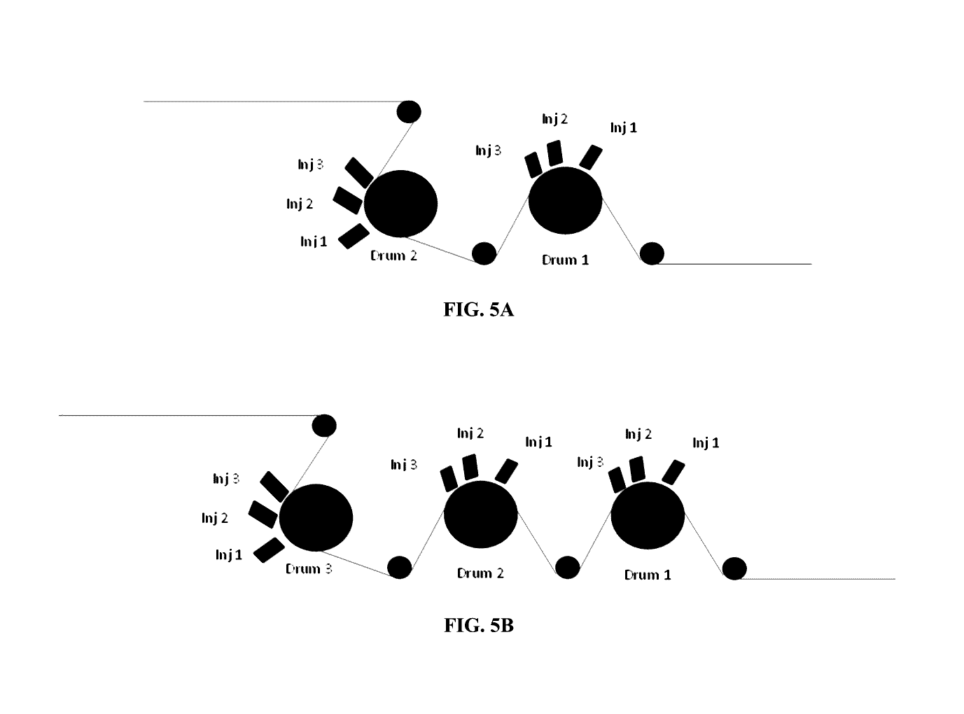

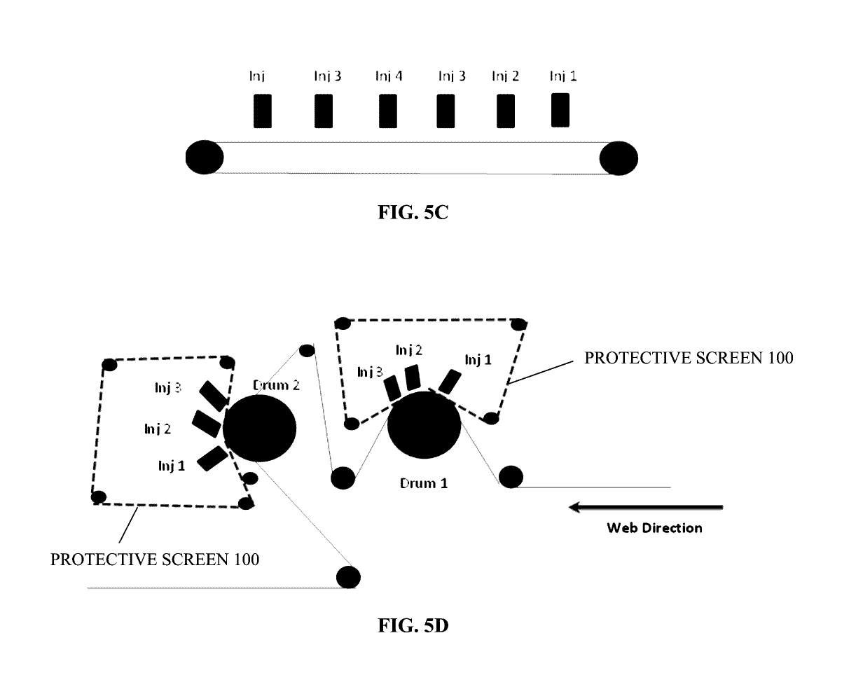

A three-layer composite web was made with a 35 gsm paper web sandwiched between two nonwoven webs. One of the nonwoven webs was made of a multilayer, continuous filament, polypropylene nonwoven, weighing 10 gsm, and thermally bonded with a traditional 18% land area, oval bond pattern, coated with surfactant to impart hydrophilicity. The other nonwoven web was made of a multilayer, continuous filament, polypropylene nonwoven, weighing 15 gsm, and lightly thermally bonded with a traditional 18% land area, pillowbond pattern, containing a soft-additive polypropylene resin formulation. The paper web was made using a TAD paper machine. The paper web was made of 3 layers. The flow to each layer of the headbox was about 33% of the total sheet. The three layers of the finished paper web from top to bottom were labeled as air, core and dry. The air layer is the outer layer that is placed on the TAD fabric, the dry layer is the outer layer that is closest to the surface of the Yankee dryer and the core is the center section of the tissue. The tissue was produced with 100% softwood fiber in all layers. Headbox pH was controlled to 7.0 by addition of a caustic to the thick stock before the fan pumps for all samples. Paper web was produced with the addition of permanent wet strength Kymene 821 (PAE resin supplied by Solenis) at add-on levels of at least 6 kg/ton. Also a dry strength additive, Redibond 2038 (Corn Products, 10 Finderne Avenue, Bridgewater, N. J. 08807) at an add-on rate of 1 kg/Ton was added to the core layer. The HE unit shown in FIG. 5B was used to hydro-entangle the three layers (two nonwoven webs and the one paper web) to form the composite structure. HE energy conditions were 120 and 160 bar from two of the injection manifolds of drum 1; 180 and 210 bar from two of the injection manifolds of drum 2; and 190 and 200 bar from two of the injection manifolds of drum 3. A standard MPC-100 shell (supplied by Andritz of Montbonnot, France) was used on all three drums 1, 2 and 3 to pattern the composite web. The average line speed during production of the composite structure was 200 mpm.

### EXAMPLE 6

The same process described in Example 5 was used to form a composite web, except that the average line speed was 250 mpm and the HE energy conditions were altered so that pressures were at 200 and 230 from two of the injection manifolds of drum 3.

### EXAMPLE 7

The same process described in Example 5 was used to form a composite web, except that both nonwoven webs were made of a multilayer, continuous filament, polypropylene nonwoven, weighing 15 gsm, and lightly thermally bonded with a traditional 18% land area, pillowbond pattern, containing a soft-additive polypropylene resin formulation, the average line speed was 150 mpm, the HE energy conditions were altered so that pressures were at 200 and 200 from two of the injection manifolds of drum 3 and a standard 9010P shell (supplied by Andritz of Montbonnot, France) was used on drum 3.

### EXAMPLE 8

The same process described in Example 7 was used to form a composite web, except that the average line speed was 200 mpm and the 100 MPC shell was used on drum 3.

In all of Examples 5-9, the produced composite web exhibited excellent lamination and structural integrity. Other material properties of the composite webs are provided in Table 1 and were obtained using the following test methods:

Tensile Test Method: WSP 110.4 (05) B with a 100 mm grip distance

Handle-O-Meter: INDA IST 90.3-95 with a 4″×4″ sample size

Absorption Capacity: Test procedure is as follows:
a. Cut sample using the 10 cm×10 cm die cutter
b. Weigh sample and record initial weight
c. Dunk the sample in the 250 mL beaker that contains 150+mL water; use glass stirring rod to completely submerge sample
d. Start timer—leave sample submerged for 1 minute
e. After 1 minute remove the sample using the tweezers
f. Hang the sample vertically to dry for 1 minute. (Run fingers at the bottom edge of sample while still hanging to remove any pooled up fluid).
g. After 1 minute weigh the sample and record the final weight
h. Calculations:
   i. Capacity in grams fluid/grams of material
   ii. Final weight−(minus) Initial Weight÷(divided by) Initial Weight×100

TABLE 1

| | | | | MD | CD | CD |
|---|---|---|---|---|---|---|
| EXAM- | BW, | Thickness, | Absorption | Tensile, | Tensile, | Handle-O- |
| PLE | gsm | mm | Capacity, % | g/cm | g/cm | Meter, g |
| 5 | 62.7 | 0.54 | 563 | 1610 | 422 | 40.4 |
| 6 | 67.8 | 0.63 | 585 | 1588 | 497 | 40.3 |
| 7 | 70.4 | 0.79 | 543 | 1994 | 835 | 22.0 |
| 8 | 75.8 | 0.72 | 590 | 2112 | 772 | 25.3 |

According to another exemplary embodiment of the invention, a two layer composite web is formed with a sacrificial layer or protective screen functioning as a protective layer during the hydroentangling process. For example, as shown in FIG. 5D, a protective screen 100 is conveyed between the water jets and the composite structure so as to protect the composite structure during the hydroentangling process. The protective screen 100 may be, for example, a synthetic polymer screen. Alternatively, if a sacrificial layer is used, portions of the sacrificial layer that remain after the hydroentangling process are removed to produce the two-layer composite web. In a preferred embodiment, if a three drum hydroentangling process is used, the sacrificial layer is directly exposed to the jets only at one of the three drums to avoid over-entangling.

According to another exemplary embodiment of the invention, the two-layer composite web is produced by unwinding a paper web and a spunmelt web simultaneously into the hydroentangling unit as shown in FIG. 5D. Alternatively, the paper web can also be unwound directly onto a spunmelt web layer produced in-line on a spunmelt machine and then fed into the hydroentangling unit as shown in FIG. 5D. In both cases, the paper web is on the top of the spunmelt layer and is sandwiched between the protective screen and spunmelt web layer.

The following example relates to the use of a sacrificial layer according to an exemplary embodiment of the present invention:

### EXAMPLE 10

The same process described in Example 6 was used to a form a composite web, except that one of the nonwoven layers was used as a sacrificial layer during the hydroentangling process. The final composite web product (produced at 250 mpm line speed) had a basis weight of 48.7 gsm, a thickness of 0.49 mm, an absorption capacity of 492%, MD tensile strength of 945 g/cm, CD tensile strength of 376 g/cm and a CD Handle-O-Meter of 25.7 g.

While in the foregoing specification a detailed description of a specific embodiment of the invention was set forth, it will be understood that many of the details herein given may be varied considerably by those skilled in the art without departing from the spirit and scope of the invention.

1. A wipe product comprising:
a composite structure comprising at least one paper web layer and at least one nonwoven web layer.

2. The wipe product of claim 1, wherein the composite structure comprises two nonwoven web layers, and the paper web layer is disposed between the two nonwoven web layers.

3. The wipe product of claim 1, wherein the at least one nonwoven web layer is a carded web.

4. The wipe product of claim 1, wherein the at least one nonwoven web layer is a spunmelt web.

5. The wipe product of claim 1, wherein the at least one nonwoven web layer is a spunmelt web, a meltblown web or a combination thereof.

6. The wipe product of claim 1, wherein the composite structure is bonded by a hydro entangling process.

7. The wipe product of claim 1, wherein the at least one paper web layer is made of hemp fibers.

8. The wipe product of claim 1, wherein the at least one paper web layer is a multi-layered web comprised of both softwood and hardwood pulp fibers.

9. The wipe product of claim 1, wherein the at least one paper web layer comprises a permanent wet strength additive.

10. The wipe product of claim 1, wherein the at least one paper web layer comprises a temporary wet strength additive.

11. The wipe product of claim 1, wherein fiber used to form the at least one paper web layer is processed to a kappa number less than 100.

12. The wipe product of claim 1, wherein the at least one paper web layer is made of a structured paper web.

13. The wipe product of claim 1, wherein the composite structure has an MD/CD tensile ratio range of 2.0 to 3.0.

14. The wipe product of claim 1, wherein the composite structure has an absorbency capacity in the range of 400% to 1000%.

15. A method of forming a wipe product, comprising:
providing at least one paper web layer and at least one nonwoven web layer; and
hydroentangling the at least one paper web layer with the at least one nonwoven web layer to form a composite structure.

16. The method of claim 15, wherein the at least one paper web layer is made of a structured paper web, and the hydroentangling step imparts the structure of the structured paper web to the at least one nonwoven web layer.

17. The method of claim 15, wherein the wipe product is formed using an average line speed of greater than 150 mpm.

18. The method of claim 15, wherein the wipe product is formed using an average line speed of 150 mpm to 250 mpm.

19. The method of claim 15, wherein the step of hydroentangling comprises
conveying the at least one paper web layer and the at least one nonwoven web layer over two or more hydroentangling drums.

20. The method of claim 15, wherein the composite structure is a two-layered structure comprising a paper web layer and a nonwoven web layer.

21. The method of claim 20, wherein the step of hydroentangling comprises:
providing the paper web layer and the nonwoveb web layer with a protective layer.

22. The method of claim 21, wherein the protective layer is a sacrificial layer.

23. The method of claim 21, wherein the protective layer is a protective screen.

24. The method of claim 21, wherein the method is carried out at machine speeds of 150 to 500 mpm.

25. The method of claim 21, wherein the method is carried out at machine speeds of 250 to 300 mpm.
